(19) United States
(12) Patent Application Publication
(10) Pub. No.: US 2009/0009943 A1
(43) Pub. Date: Jan. 8, 2009

(54) PLASMA DISPLAY DEVICE

(76) Inventor: Dong-jin Ha, Suwon (KR)

Correspondence Address: CHRISTIE, PARKER & HALE, LLP, PO BOX 7068, PASADENA, CA, 91109-7068, US

(21) Appl. No.: 12/133,284

(22) Filed: Jun. 4, 2008

(30) Foreign Application Priority Data
Jul. 6, 2007 (KR) 10-2007-0067913

(51) Int. Cl. G06F 1/16

(52) U.S. Cl. 361/681

(57) ABSTRACT

A plasma display device including a plasma display module having a plasma display panel and a chassis frame coupled to each other; a stand facing a supporting surface to maintain the plasma display module in an erect state; a bracket having a structure for coupling the stand and being on a central vertical axis of the chassis frame; and a reinforced material for reinforcing strength of the chassis frame, the reinforced material extending diagonally from the bracket toward a vertex of the chassis frame and coupled to the chassis frame and the bracket.

### CROSS-REFERENCE TO RELATED APPLICATION

This application claims priority to and the benefit of Korean Patent Application No. 10-2007-0067913, filed on Jul. 6, 2007, in the Korean Intellectual Property Office, the entire content of which is incorporated herein by reference.

### BACKGROUND

1. Field of the Invention

The present invention relates to a plasma display device, and more particularly to a plasma display device with a chassis frame employing a bracket and a diagonal brace coupled to the bracket.

2. Description of Related Art

In general, a plasma display device is a flat panel display that can be manufactured with a small thickness and a large screen having a wide viewing angle. Referring to FIG. 1, a plasma display device 100 includes a plasma display module 130. The plasma display module 130 includes a plasma display panel 110 for displaying an image utilizing a gas discharge; and a chassis frame 120 disposed in the rear of the plasma display panel 110 to support the plasma display panel 110. The plasma display module 130 is manufactured by forming an electrode, a barrier rib, a phosphor layer and the like on a pair of glass substrates, sealing the electrode, the barrier rib and the phosphor layer with an inner space of the pair of glass substrates, and exhausting air from the inner space to manufacture a plasma display panel 110, and coupling the chassis frame 120 to the rear of the plasma display panel 110 to support the plasma display panel 110, followed by mounting circuit boards for driving the plasma display panel 110 in the rear of the chassis frame 120.

The chassis frame 120 functions to support the plasma display panel 110 and dissipate the heat generated in the plasma display panel 110. For this purpose, the chassis frame 120 is formed by subjecting metals, such as aluminum and the like having a good thermal conductivity, to a casting process and/or a pressing process. Also, since the chassis frame 120 may be deformed by the total weight of the plasma display module 130, or by thermal deformation caused by the heat generated in the plasma display panel 110, a plurality of reinforcement members 150 may be installed in the rear of the chassis frame 120 to give an additional rigidity to the chassis frame 120.

In order to repair the plasma display module 130 as configured above, or to arrange the plasma display module 130 vertically (or in an erect state) to a bottom surface (or supporting surface), an erect member, such as a stand 170, for erecting the plasma display module 130, is provided so that the plasma display module 130 can be arranged vertically to the bottom surface. In addition, a coupling member, such as a guide stand 160, is provided for coupling the plasma display module 130 to the stand 170.

If the plasma display module 130 is manufactured with a large area, the chassis frame 120 may be bent in vertical and/or horizontal directions because the chassis frame 120 may not have a sufficient strength. For this reason, the chassis frame 120 has a problem that a manufacturing cost may be high due to the use of additional reinforced structure.

Also, a configuration utilizing two stands, as shown in FIG. 1, may not be aesthetically pleasing. However, if only one stand is utilized to support a large plasma display module, the strengths of its chassis frame and stand coupling units should be very high, but this may increase the manufacturing cost.

### SUMMARY OF THE INVENTION

An aspect of an embodiment of the present invention is directed toward a plasma display device with a bracket capable of coupling reinforced materials to a chassis frame to increase the strength of a display module utilizing the bracket to fix (or couple) a stand to the chassis frame.

Another aspect of an embodiment of the present invention is directed toward a structure capable of increasing the strength of a large display module with a low cost.

An embodiment of the present invention provides a plasma display device including a plasma display module having a plasma display panel and a chassis frame coupled to each other; a stand facing a supporting surface to maintain the plasma display module in an erect state; a bracket having a structure for coupling the stand and being on a central vertical axis of the chassis frame; and a reinforced material for reinforcing strength of the chassis frame, the reinforced material extending diagonally extended the bracket toward an vertex of the chassis frame and coupled to the chassis frame and the bracket.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective schematic showing a plasma display device utilizing two stands.

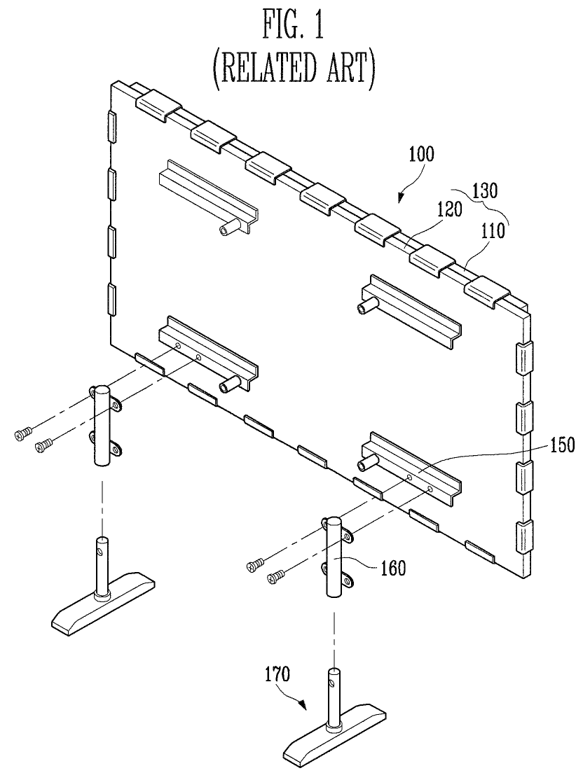

FIG. 2a is a perspective schematic showing a plasma display device utilizing a single stand according to an embodiment of the present invention.

FIG. 2b is a cross-sectional schematic showing a bracket of the plasma display device as shown in FIG. 2a.

FIG. 3 is a perspective schematic showing a plasma display device utilizing a single stand according to another embodiment of the present invention.

FIG. 4 is a perspective schematic showing a plasma display device utilizing a single stand according to still another embodiment of the present invention.

FIGS. 5a and 5b are perspective schematics showing a plasma display device utilizing a single stand according to yet another embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Here, when a first element is described as being coupled to a second element, the first element can be directly coupled to the second element or indirectly coupled to the second element via one or more third elements. Like reference numerals designate like elements throughout the specification.

### Embodiments

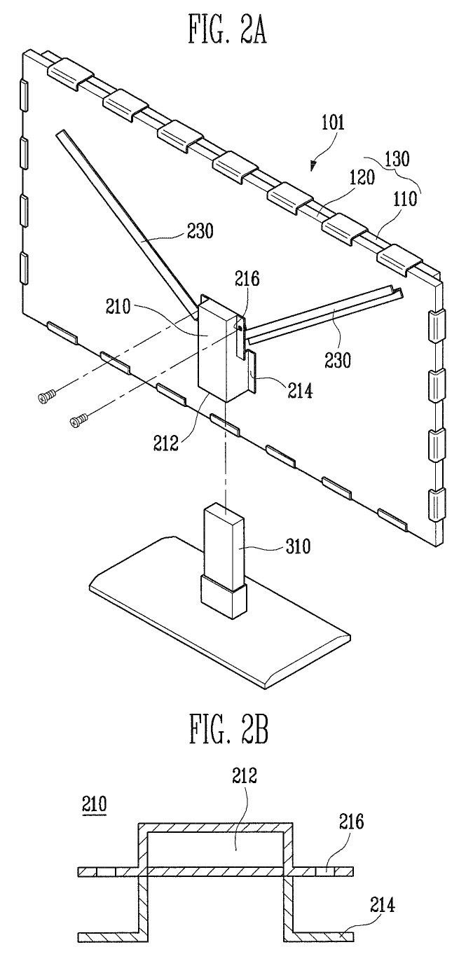

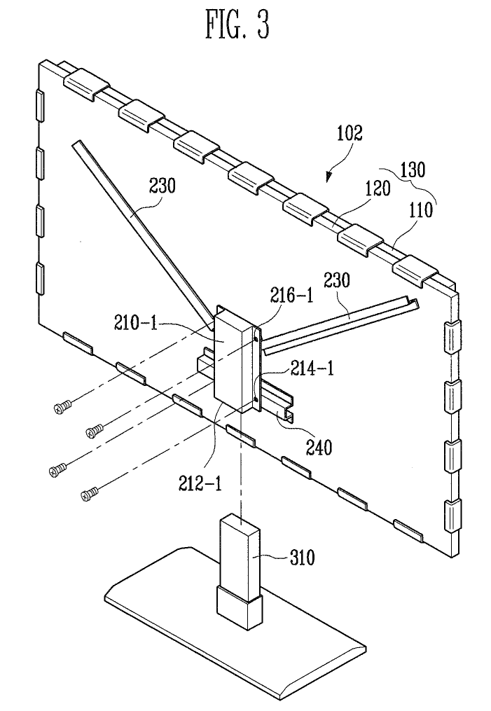

As shown in FIGS. 2a and 2b, a plasma display device 101 according to a first embodiment of the present invention includes a plasma display module 130 having a plasma display panel 110 and a chassis frame 120 coupled to each other; a stand 310 facing a supporting surface (e.g., the ground) to maintain the plasma display module in an erect state; a bracket 210 having a structure for coupling the stand 130 and being on a central vertical axis of the chassis frame 120; and one or more diagonal braces 230 for reinforcing strength of the chassis frame 120, the diagonal braces 230 extending diagonally from the bracket 210 toward an vertex of the chassis frame 120 and coupled to the chassis frame 120 and the bracket 210.

As such, the stand 310, according to this embodiment, is a single stand coupled onto a central vertical axis of the plasma display module 130. The single stand has an excellent aesthetic sense, compared to the general plasma display device with two stands, but a reinforcing mechanism for reinforcing strength of the plasma display module should be added.

If the plasma display module has a single stand, one or more diagonal braces (or reinforced material) are included as the reinforcing mechanism in an embodiment of the present invention to reinforce strength of the plasma display module, the diagonal braces being used for reinforcing strength of the plasma display module in a diagonal direction. A scheme or process of simply adding a reinforced material over another in a diagonal direction of the chassis frame is not desirable due to the waste of space and materials. Therefore, in an embodiment of the present invention, the waste of materials and space is prevented (or reduced) and a sufficient strength is ensured in addition to the contribution to strength of the bracket and strength of the diagonal brace, by coupling the diagonal braces to a bracket for coupling to the single stand.

As shown in FIG. 2a, the diagonal braces 230 are coupled to the chassis frame 120 to improve the contribution to strength of the chassis frame 120. Here, a sheet-to-sheet clinched joint or a sheet metal joining process such as a sheet-to-sheet clinching process or a TOX® process (hereinafter, referred to as a TOX process) or the like may be used for this purpose. It is possible to use a coupling member such as a rivet or a screw. However, one embodiment of the present invention couples the diagonal braces 230 to the chassis frame 120 by utilizing the sheet-to-sheet clinching process or the sheet metal joining process so as to maintain strength of the chassis frame 120.

The coupling of the bracket 210 and the chassis frame 120 may be carried out utilizing a sheet metal joining process such as a TOX process. However, one embodiment of the present invention couples the bracket 210 to the chassis frame 120 by utilizing a coupling member such as a rivet or a screw for purposes of convenience of manufacturing.

The bracket 210 may be composed of a stand coupling unit 212 to fit (or couple) the stand 310 inwardly into itself (i.e., to receive the stand 310); a chassis connection unit 214 coupled to the chassis frame 120; and one or more reinforced material coupling units 216 coupled to the diagonal braces 230.

The stand coupling unit 212 may be a coupling chamber into which a portion of the stand 310 may be inserted inwardly into the coupling chamber. Here, the coupling chamber (of the stand coupling unit 212) may serve to reinforce the strength to the chassis frame 120 if it is coupled to the chassis frame 120 because the coupling chamber itself has a considerable (or high) strength.

The chassis connection unit 214 is adapted to couple the bracket 210 to the chassis frame 120. In the embodiment as shown, the chassis connection unit 214 is coupled to the chassis frame 120 utilizing a sheet metal joining process such as a TOX process.

The reinforced material coupling units 216 are configured to couple one end of the diagonal braces 230, and include a coupling-member coupling hole such as a rivet/screw hole, as shown in FIGS. 2a and 2b.

A separate reinforced material for reinforcing strength of a panel in vertical and/or horizontal directions may be further provided onto the chassis frame 120. Differences between the separate reinforced material and the diagonal braces 230 according to one embodiment of the present invention depend on the reinforcement of strength in a diagonal direction and/or the coupling to the central bracket (e.g., the bracket 210).

Also, like the general plasma display devices, the plasma display device 101 may be configured so that components such as a drive circuit for driving a plasma display panel can be attached to one side of a display panel having a bracket installed therein. Also, the plasma display device 101 may further include a housing for housing one surface of the plasma display panel 110, the supporting bracket and some of the stand installed inside to protect the surface of the display panel, the supporting bracket and some of the stand.

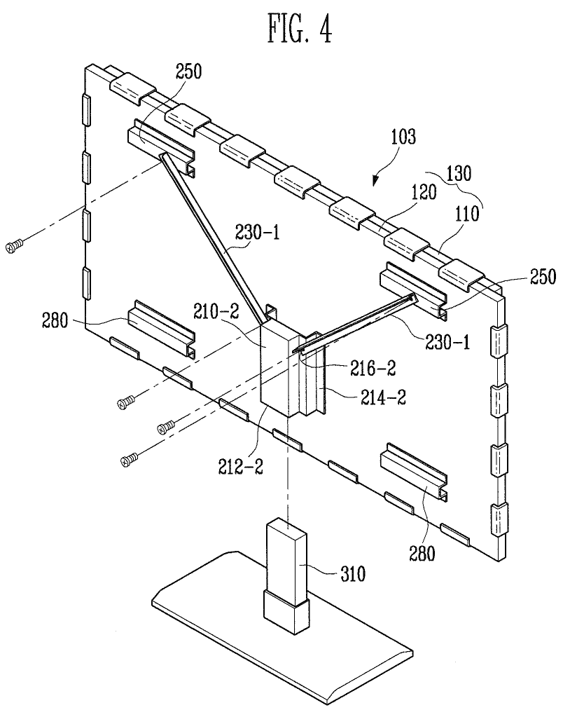

As shown in FIG. 3, a plasma display device 102 according to a second embodiment of the present invention includes a plasma display module 130 having a plasma display panel 110 and a chassis frame 120 coupled to each other; a stand 310 facing a supporting surface to maintain the plasma display module 130 in an erect state; a bracket 210-1 having a structure for coupling the stand 310 and being on a central vertical axis of the chassis frame 120; a bracket-coupling reinforced material 240 coupled to a bracket coupling region formed on the chassis frame 120 and having the bracket 210-1 coupled onto the chassis frame 120; and one or more diagonal braces 230 for reinforcing strength of the chassis frame 120, the diagonal braces 230 extending diagonally from the bracket 210-1 toward a vertex of the chassis frame 120 and coupled to the chassis frame 120 and the bracket 210-1.

In the shown plasma display device 102, components are substantially identical to those as shown in FIG. 2, except that the bracket-coupling reinforced material 240 is included and a configuration of the bracket 210-1 that is coupled to the bracket-coupling reinforced material 240 is modified.

As shown in FIG. 3, a sheet metal joining process such as a TOX process may be used to couple the bracket-coupling reinforced material 240 to the chassis frame 120. The bracket 210-1 is put on the bracket-coupling reinforced material 240, and the bracket 210-1 is then coupled to the bracket-coupling reinforced material 240 utilizing a coupling member 214-1 such as a rivet/screw hole and a rivet or a screw. That is, in one embodiment as shown, the bracket 210-1 is not directly coupled to the chassis frame 120, but indirectly coupled to the chassis frame 120 through the bracket-coupling reinforced material 240.

In addition, as shown in FIG. 3, the bracket 210-1 also includes a stand coupling unit 212-1 to fit (or couple) the stand 310 inwardly into itself (i.e., to receive the stand 310) and one or more reinforced material coupling units 216-1 coupled to the diagonal braces 230.

In FIG. 3, the plasma display device 102 has one bracket-coupling reinforced material 240, but may include at least two bracket-coupling reinforced materials to increase adhesion of the chassis frame 120 to the bracket 210-1. Also, the bracket-coupling reinforced material 240 is manufactured to give strength to the bracket-coupling reinforced material 240 in a horizontal direction, but it is possible to use a bracket-coupling reinforced material 240 coupled to the chassis frame 120 in other directions.

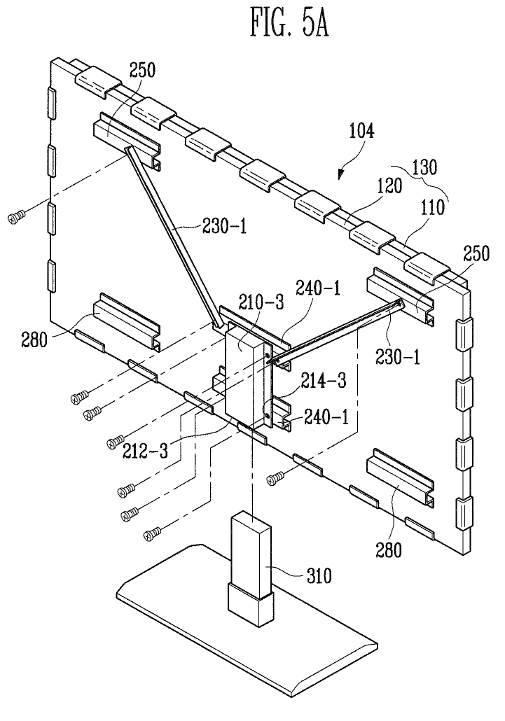

As shown in FIG. 4, a plasma display device 103 according to a third embodiment of the present invention includes a plasma display module 130 having a plasma display panel 110 and a chassis frame 120 coupled to each other; a stand 310 facing a supporting surface to maintain the plasma display module in an erect state; a bracket 210-2 having a structure for coupling the stand 310 and being on a central vertical axis of the chassis frame 120; one or more additional reinforced materials 250 for reinforcing strength of the chassis frame 120 in a horizontal direction; and one or more diagonal braces 230-1 for reinforcing strength of the chassis frame 120, the diagonal braces 230-1 extending diagonally from the bracket 210-2 toward a vertex of the chassis frame 120, one end of which is coupled to the bracket 210-2 and the other end of which is coupled to the additional reinforced materials 250.

In the shown plasma display device 103, components are substantially identical to those as shown in FIG. 2, except for the additional reinforced materials 250 and a coupling method of the diagonal braces 230-1.

As shown in FIG. 4, the diagonal braces 230-1 of this embodiment are not directly coupled to the chassis frame 120, but rather the ends of the diagonal braces 230-1 are coupled to the bracket 210-2 and the additional reinforced materials 250 with a space between a central region of the diagonal braces 230-1 and the chassis frame 120, by utilizing one or more coupling members (e.g., reinforced material coupling units 216-2). Such a configuration has a reduces effect of reinforcing strength of the chassis frame 120 than in a complete joining process, but the reduction in use of a space of the chassis frame 120 may be prevented (or reduced) due to the diagonal braces 230-1. That is, plasma display device components such as a control circuit board may be disposed on the chassis frame 120 below the central region of the spaced diagonal braces 230-1.

The coupling of the diagonal braces 230-1 to the bracket 210-2 may be carried out utilizing a coupling member such as a rivet or a screw. The coupling of the chassis frame 120 to the bracket 210-2 according to the embodiment as shown may also be carried out by utilizing a coupling member such as a rivet or a screw, but, in the embodiment as shown, a chassis connection unit 214-2 is utilized by utilizing a joining process such as a TOX process.

Separate reinforced materials 280 for reinforcing strength of a panel in vertical and/or horizontal directions may be further provided onto the chassis frame 120. Among a plurality of the separate reinforced materials 280, a reinforced material arranged in the most remote position from the bracket 210-2 (e.g., two vertex regions as shown in FIG. 4) is utilized in one embodiment of the present invention for application as the separate reinforced materials 280 of this embodiment. This is to increase (or maximize) a region in which the diagonal braces 230-1 reinforce strength without forming an additional structure.

The additional reinforced materials 250 coupled to the diagonal braces 230-1 are different from the separate reinforced materials 280 in that the additional reinforced materials 250 include a chassis frame-united reinforcement structure composed of “additional reinforced materials—diagonal brace—bracket.”

In addition, as shown in FIG. 4, the bracket 210-2 also includes a stand coupling unit 212-2 to fit (or couple) the stand 310 inwardly into itself (i.e., to receive the stand 310)

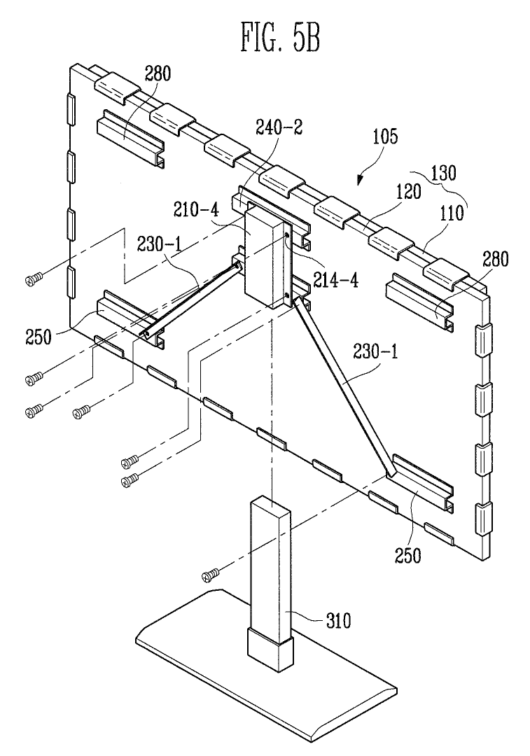

As shown in FIGS. 5a and 5b, a plasma display device 104, 105 according to a fourth embodiment of the present invention includes a plasma display module 130 having a plasma display panel 110 and a chassis frame 120 coupled to each other; a stand 310 facing a supporting surface to maintain the plasma display module in an erect state; a bracket 210-3, 210-4 having a structure for coupling the stand 310 and being on a central vertical axis of the chassis frame 120; one or more bracket-coupling reinforced materials 240-1, 240-2 coupled to a bracket coupling region formed on the chassis frame 120 and having the bracket 210-3, 210-4 coupled onto the chassis frame 120; one or more additional reinforced materials 250 for reinforcing strength of the chassis frame 120 in a horizontal direction; and one or more diagonal braces 230-1 for reinforcing strength of the chassis frame 120, the diagonal brace 230-1 extending diagonally from the bracket 210-3, 210-4 toward a vertex of the chassis frame 120, one end of which is coupled to the bracket 210-3, 210-4 and the other end of which is coupled to the additional reinforced materials 250.

Also, the bracket 210-3, 210-4 is put on the bracket-coupling reinforced materials 240-1, 240-2, and the bracket 210-3, 210-4 is then coupled to the bracket-coupling reinforced materials 240-1, 240-2 utilizing a coupling member 214-3, 214-4 such as a rivet/screw hole and a rivet or a screw.

In addition, as shown in FIG. 5a, the bracket 210-3 is also includes a stand coupling unit 212-3 to fit (or couple) the stand 310 inwardly into itself (i.e., to receive the stand 310)

In the shown plasma display device 104, 105 of FIGS. 5a and 5b, the bracket-coupling reinforced materials 240-1, 240-2 and the bracket 210-3, 210-4 coupled to the bracket-coupling reinforced materials 240-1, 240-2 are substantially identical to those as shown in FIG. 3, and components other than the bracket-coupling reinforced materials 240-1, 240-2 and the bracket 210-3, 210-4 are substantially identical to those as shown in FIG. 4.

The bracket 210-3 as shown in FIG. 5a is on a lower portion of the chassis frame 120, and the diagonal braces 230-1 coupled to the bracket 210-3 may extend upwardly from a lower portion near a central axis of the chassis frame 120 toward an upper vertex, whereas the bracket 210-4 as shown in FIG. 5b is on an upper portion of the chassis frame 120, and the diagonal braces 230-1 coupled to the bracket 210-4 may extend downwardly from a upper portion near a central axis of the chassis frame 120 toward a lower vertex.

Also, it is apparent to those skilled in the art that the plasma display device can be realized in the case of FIGS. 2 to 4 so that the diagonal braces can be extended upwardly from a lower portion near a central axis of the chassis frame 120 toward an upper vertex, as shown in FIG. 5b.

The brackets 210-3, 210-4 and the diagonal braces 230-1, according to the embodiments of FIGS. 5a and 5b, are not directly coupled to each other, but indirectly coupled to each other through the bracket-coupling reinforced materials 240-1, 240-2 that can couple the bracket 210-3, 210-4 and the diagonal braces 230-1, respectively. Accordingly, it might be seen that a chassis frame-united reinforcement structure according to this embodiment is composed of “additional reinforced materials—diagonal brace—bracket-coupling reinforced materials—bracket”.

As described above, a plasma display device having a chassis frame and a diagonal brace according to an embodiment of the present invention can reinforce the strength of the display module.

Also, a plasma display device having a chassis frame and a diagonal brace according to an embodiment of the present invention can reinforce a large display module with a low cost while being aesthetically pleasing.

Also, a more improved plasma display device according to an embodiment of the present invention having a chassis frame and one or more diagonal braces can also increase (or maximize) the use of a space in the rear of the display module while reinforcing strength of the display module.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display device, comprising:
a plasma display module comprising a plasma display panel and a chassis frame coupled to each other;
a stand facing a supporting surface to maintain the plasma display module in an erect state;
a bracket comprising a structure for coupling the stand and being on a central vertical axis of the chassis frame; and
a reinforced material for reinforcing strength of the chassis frame, the reinforced material extending diagonally from the bracket toward a vertex of the chassis frame and coupled to the chassis frame and the bracket.

2. The plasma display device according to claim 1, wherein the bracket comprises:
a stand coupling unit for inwardly fitting at least a part of the stand to couple the bracket to the stand;
a chassis connection unit for coupling the bracket to the chassis frame; and
a reinforced material coupling unit for coupling the bracket to the reinforced material.

3. The plasma display device according to claim 2,
wherein the chassis connection unit is bonded to the chassis frame utilizing a sheet-to-sheet clinched joint.

4. The plasma display device according to claim 2,
wherein the reinforced material coupling unit comprises a rivet hole or a screw hole.

5. The plasma display device according to claim 1,
wherein the reinforced material is bonded to the chassis frame utilizing a sheet-to-sheet clinched joint.

6. The plasma display device according to claim 1, further comprising an additional reinforced material coupled to one end of the reinforced material for reinforcing strength of the chassis frame,
wherein another end of the reinforced material is coupled to the bracket.

7. The plasma display device according to claim 6,
wherein the additional reinforced material is arranged at two vertex regions, out of four vertex regions of the chassis frame, remote from the bracket.

8. The plasma display device according to claim 1, further comprising a bracket-installing reinforced material for reinforcing strength of the chassis frame and disposed between the bracket and the chassis frame to couple the chassis frame to the bracket.

9. The plasma display device according to claim 8, further comprising an additional reinforced material coupled to one end of the reinforced material and for reinforcing strength of the chassis frame,
wherein another end of the reinforced material is coupled to the bracket-installing reinforced material.

10. The plasma display device according to claim 1, further comprising a housing having one surface of the display panel, the supporting bracket and a part of the stand installed inside to protect the surface of the display panel, the supporting bracket and the part of the stand.

11. A plasma display device, comprising:
a plasma display panel;
a chassis frame coupled to the plasma display panel;
a stand facing a supporting surface to maintain the plasma display panel with the chassis frame in an erect state;
a bracket having a structure for coupling the stand and being on a central vertical axis of the chassis frame; and
a reinforced material for reinforcing strength of the chassis frame, the reinforced material extending diagonally from the bracket toward a vertex of the chassis frame and coupled to the chassis frame and the bracket.

12. The plasma display device according to claim 11, wherein the bracket comprises:
a stand coupling unit having a chamber into which a part of the stand is inserted;
a chassis connection unit coupling the bracket to the chassis frame; and
a reinforced material coupling unit coupling the bracket to the reinforced material.

13. The plasma display device according to claim 12,
wherein the chassis connection unit is sheet-to-sheet clinched to the chassis frame.

14. The plasma display device according to claim 12,
wherein the reinforced material coupling unit is riveted to the reinforced material.

15. The plasma display device according to claim 12,
wherein the reinforced material coupling unit is threadedly engaged to the reinforced material.

16. The plasma display device according to claim 11,
wherein the reinforced material is sheet-to-sheet clinched to the chassis frame.

17. The plasma display device according to claim 11, further comprising an additional reinforced material coupled to one end of the reinforced material for reinforcing strength of the chassis frame,
wherein another end of the reinforced material is coupled to the bracket.

18. The plasma display device according to claim 17,
wherein the additional reinforced material is arranged at two vertex regions, out of four vertex regions of the chassis frame, remote from the bracket.

19. The plasma display device according to claim 11, further comprising a bracket-installing reinforced material for reinforcing strength of the chassis frame and disposed between the bracket and the chassis frame to couple the chassis frame to the bracket.

20. The plasma display device according to claim 19, further comprising an additional reinforced material coupled to one end of the reinforced material and for reinforcing strength of the chassis frame,
wherein another end of the reinforced material is coupled to the bracket-installing reinforced material.
